(19) United States
(12) Patent Application Publication
(10) Pub. No.: US 2006/0250500 A1
(43) Pub. Date: Nov. 9, 2006

(54) Device for monitoring the exterior of a motor vehicle

(76) Inventor: Joachim Gloger, Bibertal (DE)

Correspondence Address: AKERMAN SENTERFITT, P.O. BOX 3188, WEST PALM BEACH, FL, 33402-3188, US

(21) Appl. No.: 10/535,302

(22) PCT Filed: Aug. 17, 2004
(86) PCT No.: PCT/EP04/09195

§ 371 Date: Jul. 10, 2006

(30) Foreign Application Priority Data
Sep. 17, 2003 (DE) 103 42 971.9

(51) Int. Cl. H04N 7/18; H04N 7/00; H04N 9/47

(52) U.S. Cl. 348/148; 348/36

(57) ABSTRACT

In a device for the external monitoring of a motor vehicle, comprising at least one camera, it is envisaged that the camera is disposed in the region of a pivot axis of a rear window wiper of the motor vehicle.

### BACKGROUND OF THE INVENTION

1. Field of the invention

The invention relates to a device for the external monitoring of a motor vehicle of the type more closely defined in the preamble to claim 1.

2. Related Art of the Invention

A device of the generic type is known, for example, from DE 202 14 892 U1. To a body part of the motor vehicle, in this case a bumper, there is attached a carrier unit, which is provided with two cameras so as to be able to monitor regions on both sides of the motor vehicle. Although this offers the possibility of integrating a camera into a motor vehicle, the drawbacks are the relatively costly construction and the inadequate or lacking all-round visibility.

The basic problem with accommodating cameras on or in motor vehicles is always their size, since this can only be reduced at unjustifiable expense, so that considerable difficulties sometimes arise both with regard to the design and with regard to the construction.

### SUMMARY OF THE INVENTION

The object of the present invention is therefore to provide a device for the external monitoring of a motor vehicle comprising at least one camera, which is integrated into the motor vehicle at low cost, does not overly interfere with the motor vehicle and yet offers good all-round visibility.

According to the invention, this object is achieved by the features stated in claim 1.

By accommodating the camera in the region of a pivot axis of a rear window wiper of the motor vehicle according to the invention, a solution is obtained which, equally, is constructionally simple and is straightforward in design engineering terms. In addition, a very great advantage of the solution according to the invention is given by the fact that the camera is sited at a very advantageous location, at which a very good rear view is granted, whereby a driver of the motor vehicle, when parking, for example, enjoys considerable advantages over the customary look into the rear mirror.

A rear window wiper for a motor vehicle having a device according to the invention emerges from claim 8.

In claim 9, a motor vehicle having a rear window wiper of this type is defined.

### BRIEF DESCRIPTION OF THE DRAWINGS

Illustrative embodiments of the invention are represented in basic outline below, in which:

FIG. 1 shows a motor vehicle having a rear window wiper and a device according to the invention attached thereto, and

FIG. 2 shows the device according to the invention in the section along the line II-II from FIG. 1.

### DETAILED DESCRIPTION OF THE INVENTION

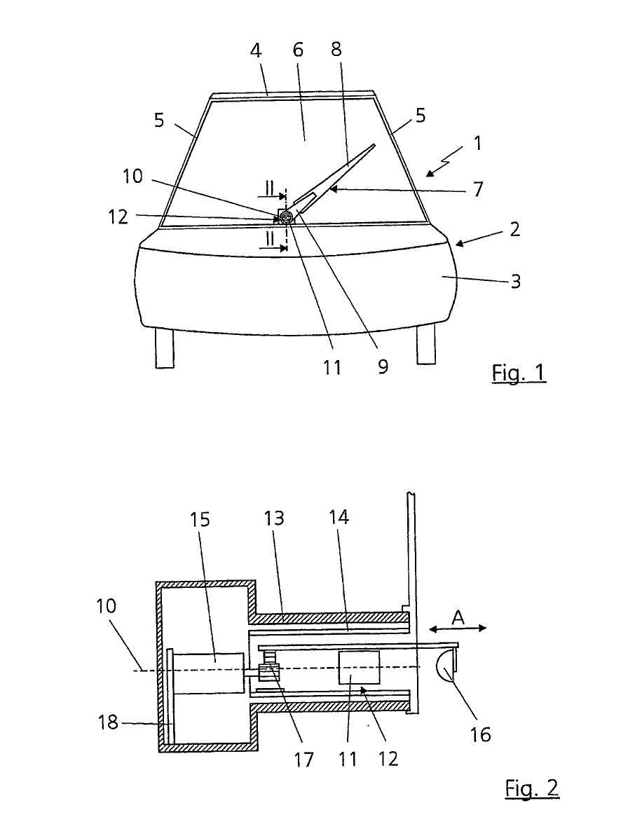

FIG. 1 shows, in rear view, a motor vehicle 1, which has a body 2 comprising a boot 3, a roof 4 and two C-pillars 5 connecting the roof 4 to the boot 3.

In a manner which is known per se, in the region between the boot 3, the roof 4 and the C-pillars 5 a rear window 6 is disposed, to which there is attached a rear window wiper 7 for wiping the same. The rear window wiper 7, which alternatively could also be attached to the boot 3 or to the top side of the rear window 6 and, where appropriate, to the roof 4, has, in a manner which is known per se, a wiper blade 8 attached to a wiper arm 9, which, in turn, is pivotable about a pivot axis 10.

In the region of the pivot axis 10 there is disposed a camera 11, which is part of a device 12 for the external monitoring of the motor vehicle 1 and is represented in greater detail in FIG. 2.

Arranged within a housing part 13 of the wiper arm 9 there is a tube 14, in which the camera 11 is disposed. The housing part 13 is thus located outside the tube 14. In the present case, the housing part 13 contains a drive motor 15, which is capable of moving a mirror 16, connected to the camera 11, relative to the tube 14 and of thus protracting the said mirror, according to the arrow denoted by “A”, out of the wiper arm 9, the camera 11 remaining protected in the tube 14. In order to combat possible difficulties in changing the distance between the camera 11 and the mirror 16, both the camera 11 and the mirror 16 can also be moved as a mutually linked unit.

It is preferably envisaged that the drive motor 15 is also used to move the rear window wiper 7. For the driving of the mirror 16, the drive motor 15 is connected to the same by a first gear mechanism 17. For the movement of the rear window wiper 7, the drive motor 15 is connected to the same by a second gear mechanism 18. In the present case, the camera 11 is realized as a panorama camera with a 360° range of vision, or as a so-called omnicam.

In a manner which is not represented, a power supply which is necessary for the camera 11 can run through the rear window wiper 7, using previously existing cable paths. Relative to an ordinary rear window wiper, the rear window wiper 7 is only slightly modified, for example it has a somewhat larger diameter in the region of the pivot axis 10 in order to accommodate the device 12 comprising the camera 11 and the mirror 16.

1. A device for monitoring the exterior of a motor vehicle, comprising at least one camera, wherein the camera (11) is disposed in the region of a pivot axis (10) of a rear window wiper (7) of the motor vehicle (1).

2. The device according to claim 1, wherein arranged within a housing part (13) of the rear window wiper (7) there is a tube (14), in which the camera (11) is disposed.

3. The device according to claim 2, wherein the camera (11) is held rigidly within the tube (14).

4. The device according to claim 2 wherein the camera (11) is connected to a mirror (16) which can be moved relative to the tube (14).

5. The device according to claim 4, wherein the mirror (16) can be moved by means of a drive motor (15) driving the rear window wiper (7).

6. The device according to claim 2, wherein the camera (11) is connected to a mirror (16) and can be moved with the same relative to the tube (14).

7. The device according to claim 1 wherein the camera (11) is a panorama camera with a 360° range of vision.

8. A rear window wiper for a motor vehicle having a device for monitoring the exterior of a motor vehicle, comprising at least one camera, wherein the camera (11) is disposed in the region of a pivot axis (10) of a rear window wiper (7) of the motor vehicle (1).

9. A motor vehicle having a rear window wiper having a device for monitoring the exterior of a motor vehicle, comprising at least one camera, wherein the camera (11) is disposed in the region of a pivot axis (10) of a rear window wiper (7) of the motor vehicle (1).
